(19) United States
(12) Patent Application Publication
(10) Pub. No.: US 2017/0096836 A1
(43) Pub. Date: Apr. 6, 2017

(54) ANTI-SCALE FENCE SYSTEMS

(71) Applicant: Long Fence Company, Inc., Capitol Heights, MD (US)

(72) Inventors: Michael Joseph RITTER, Mitchellville, MD (US); Lawrence FRIEDMAN, Clifton, VA (US); James Timothy DEVINE, Huntingtown, MD (US)

(73) Assignee: Long Fence

(21) Appl. No.: 14/931,539

(22) Filed: Nov. 3, 2015

Related U.S. Application Data
(60) Provisional application No. 62/235,965, filed on Oct. 1, 2015.

(51) Int. Cl. E04H 17/24; E04H 17/20; E04H 17/04; E04H 17/16; F16M 11/00; E04H 17/00

(52) U.S. Cl. CPC E04H 17/24; F16M 11/00; E04H 17/003; E04H 17/04; E04H 17/163; E04H 17/20

(57) ABSTRACT

A fence support may include a first plate having a first surface and a second surface. The first and second surfaces may extend from a first end of the support toward a second end of the support. The fence support may include a second plate coupled to the first surface of the first plate. The second plate may be smaller than the first plate and offset from edges of the first plate. The fence support also may include a first peg and a second peg each extending normal from one of the first and second plates.

### CROSS-REFERENCE TO RELATED APPLICATION(S)

This patent application claims the benefit of priority under 35 U.SC. §119 to U.S. Provisional Application No. 62/235,965, filed on Oct. 1, 2015, the entirety of which is incorporated herein by reference.

### TECHNICAL FIELD

Various examples of the present disclosure relate generally to anti-scale fence systems. More specifically, the present disclosure relates to modular, easy-to-use, fence systems that are resistant to scaling and tipping.

### BACKGROUND

Modular fences are often used to control crowds and to provide security for large events, such as, for example, parades or for gatherings featuring prominent individuals. However, conventional fences may be easily scaled, tipped, or may provide gaps which may compromise the security of the fences.

Thus, a need exists for more secure and cost-efficient fence systems.

### SUMMARY OF THE DISCLOSURE

In one aspect, the present disclosure is directed to a fence support. The fence support may include a first plate having a first surface and a second surface. The first and second surfaces may extend from a first end of the support toward a second end of the support. The fence support may include a second plate coupled to the first surface of the first plate. The second plate may be smaller than first plate and offset from edges of the first plate. The fence support also may include a first peg and a second peg each extending normal from one of the first and second plates.

The first peg and the second peg each may be disposed closer to the second end of the support than to the first end of the support. The first peg and the second peg may be offset from one another. Both the first plate and the second plate may be rectangular. The first surface and the second surface of the first plate may be generally parallel to one another, and the second surface may include an anti-skid material. The first surface of the first plate may include caution tape. The fence support may include one or more anchor holes extending from the first surface of the first plate to the second surface of the first plate. The first plate and the second plate may have the same thickness.

In another aspect, the present disclosure is directed to a fence assembly. The fence assembly may include a first fence support with a first plate having a first surface and a second surface, the first and second surfaces extending from a first end of the first fence support toward a second end of the first fence support, a second plate coupled to the first surface of the first plate, the second plate being smaller than first plate and offset from edges of the first plate, and a first peg and a second peg each extending normal from one of the first and second plates. The fence assembly may include a first fence panel having an outer frame. A first portion of the first fence panel may extend over the first peg of the first fence support to couple the first fence panel to the first fence support.

The fence assembly may include a second fence panel having an outer frame. A first portion of the second fence panel may extend over the second peg of the first fence support to couple the second fence panel to the first fence support. The fence assembly may include one or more tying members secured around both the first fence panel and the second fence panel that directly couple the first fence panel and the second fence panel to one another. The first fence panel further may include an expanded metal mesh overlapping the entire frame. The expanded metal mesh may be coupled to a side of the fence panel facing the second end of the first fence support. The first peg and the second peg may be disposed closer to the second end of the first fence support than to the first end of the first fence support. The second fence panel may be a gate that is configured to pivot about the second peg. The fence assembly may include a spacer configured to extend over a lower portion of the second peg. A hinged side of the second fence panel may extend over the second peg and rest on the spacer. The fence assembly may include a second fence panel having an outer frame. A bottom portion of the outer frame may be positioned onto the first fence support on a side of the second peg facing the second end of the support. The fence assembly may include a second fence support that is heavier than the first fence support. The second fence support may include a first plate having a first surface and a second surface, the first and second surfaces extending from a first end of the second fence support toward a second end of the second fence support, a second plate coupled to the first surface of the first plate, the second plate being smaller than first plate and offset from edges of the first plate, and a first peg and a second peg each extending normal from one of the first and second plates. A second side of the second fence panel may extend over the first peg of the second fence support.

In yet another aspect, the present disclosure is directed to a fence assembly. The fence assembly may include a first fence support with a first plate having a first surface and a second surface, the first and second surfaces extending from a first end of the first fence support toward a second end of the first fence support, a second plate coupled to the first surface of the first plate, the second plate being smaller than first plate and offset from each of the edges of the first plate, and a first peg and a second peg each extending normal from one of the first and second plates. The first peg and the second peg may be disposed closer to the second end of the first fence support than to the first end of the first fence support. The fence assembly may include a first fence panel having a frame having a first side facing the first end of the first fence support, and a second side facing the second end of the first fence support, and an expanded metal mesh overlapping an entirety of the second side of the frame of the first fence panel. A first portion of the first fence panel may extend over the first peg of the first fence support to couple the first fence panel to the first fence support.

The fence assembly may include a second fence panel having a frame having a first side facing the first end of the first fence support, and a second side facing the second end of the first fence support, and an expanded metal mesh overlapping an entirety of the second side of the frame of the second fence panel. A first portion of the second fence panel may extend over the second peg of the first fence support to couple the second fence panel to the first fence support. The fence assembly may include a second fence support that is heavier than the first fence support. The second fence support may include a first plate having a first surface and a second surface, the first and second surfaces extending from a first end of the second fence support toward a second end of the second fence support, and a second plate coupled to the first surface of the first plate, the second plate being smaller than first plate and offset from each of the edges of the first plate, and a first peg and a second peg each extending normal from one of the first and second plates. A second portion of the second fence panel may extend over the first peg of the second fence support. The fence assembly may include one or more tying members secured around both the first fence panel and the second fence panel that directly couple the first fence panel and the second fence panel to one another.

### BRIEF DESCRIPTION OF THE FIGURES

The accompanying drawings, which are incorporated in and constitute a part of this specification, illustrate various examples and together with the description, serve to explain the principles of the disclosed examples.

FIG. 1 is a perspective view of a fence system according to an example of the present disclosure.

FIG. 2 is a top view of a fence support according to one example of the present disclosure.

FIG. 3 is a side view of the fence support of FIG. 2.

FIG. 4 is a top view of a fence support according to another example of the present disclosure.

FIG. 5 is a side view of the fence support of FIG. 4.

FIG. 6 is a perspective view of a gate section according to an example of the present disclosure.

FIG. 7 is a side view of a hinge member according to one example of the present disclosure.

FIG. 8 is a front view of the hinge member of FIG. 7.

FIG. 9 is a front view of a rolling member according to one example of the present disclosure.

FIG. 10 is a top view of a spacer according to one example of the present disclosure.

FIG. 11 is a side view of the spacer of FIG. 10.

FIG. 12 is a perspective view of a gate section according to another example of the present disclosure.

### DETAILED DESCRIPTION

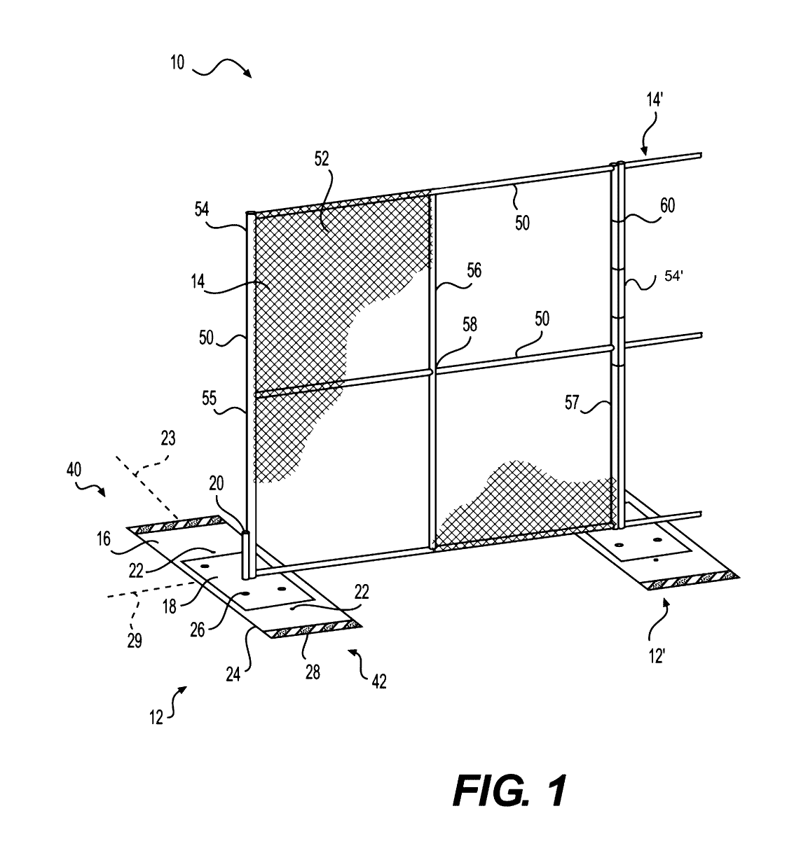

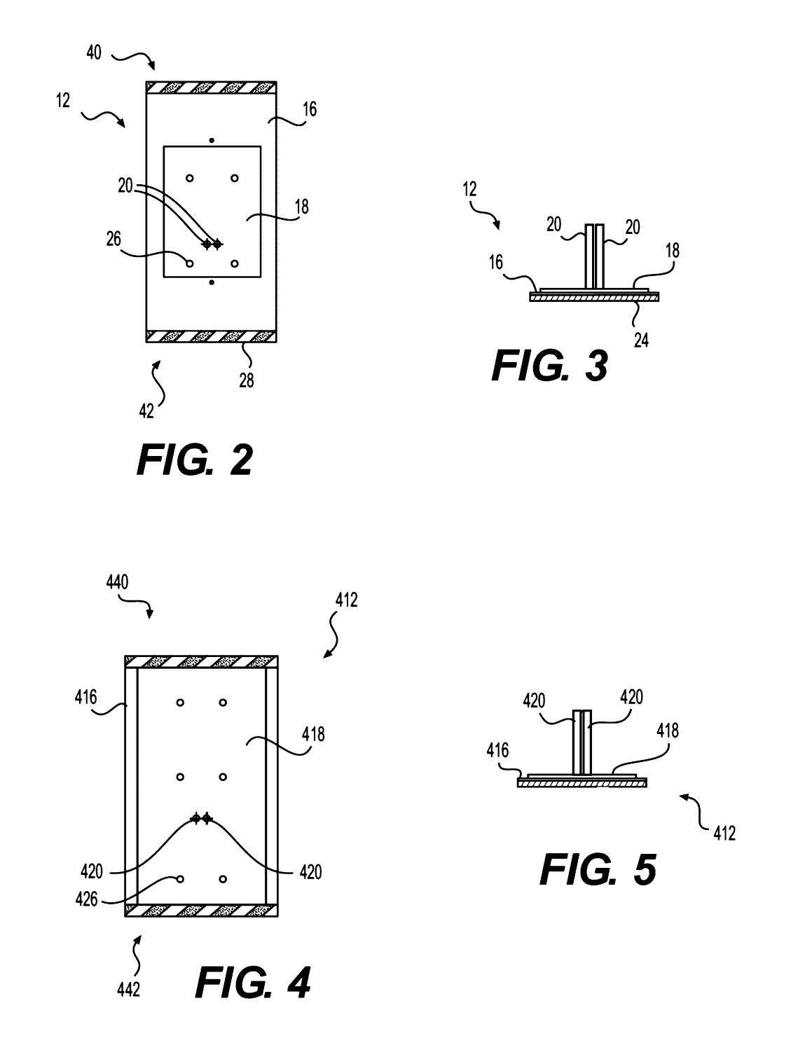

FIG. 1 depicts a fence system 10 including a support 12 (shown in more detail in FIGS. 2 and 3) and a fence panel 14. The support 12 may extend from a first end 40 toward a second end 42, and may include a first plate 16, a second plate 18, a pair of aligned pegs 20 extending generally normal to the first and second plates 16, 18, and an anti-skid membrane 24. The second plate 18 may be coupled to a first surface (e.g., a top surface) of first plate 16, while the anti-skid membrane 24 may be disposed on a second surface (e.g., a bottom surface) of first plate 16 that is generally parallel to the first surface. The first plate 16 may be formed of steel or another suitable material, and may be sized larger than the second plate 18. In one example, first plate 16 may be rectangular, and may be 48 inches by 24 inches with a ¼ inch thickness. It is contemplated that first plate 16 may also have other suitable dimensions.

First plate 16 may also include anchor holes 22 that extend from the first surface to the second surface. The anchor holes 22 may be disposed generally along a longitudinal axis 23 of first plate 16, and may be configured to receive anchoring devices (e.g., screws, nails, spikes, stake, or the like) that help anchor first plate 16 to the ground surface for additional stability. When first plate 16 and second plate 18 are mounted to one another, anchor holes 22 may be disposed on opposite ends of the second plate 18. That is, the distance between anchor holes 22 may be greater than the length of the second plate 18. Alternatively, second plate 18 may include corresponding anchor holes that are configured to line up with anchor holes 22 of first plate 16 so that an anchoring device may extend through both the first plate 16 and the second plate 18.

Second plate 18 may include one or more weld holes 26 that are configured to facilitate the joining of first plate 16 with second plate 18 by, e.g., welding. The second plate 18 may also be formed of steel and rectangular in shape, although other suitable materials and shapes are also contemplated. The second plate 18 may have dimensions, for example, of 24 inches by 20 inches with a thickness of ¼ inch.

In the example shown in FIG. 1, second plate 18 includes four weld holes 26. In some examples, weld holes 26 may be filled with welding material so that first plate 16 and second plate 18 may be coupled to one another by plug welds. Additionally, first plate 16 and second plate 18 may be coupled to one another by welding of the periphery of the smaller second plate 18. Second plate 18 may be secured to first plate 16 so that the perimeter edges of second plate 18 are not aligned with the perimeter edges of first plate 16. Thus, the periphery of support 12 may be defined by only the periphery of first plate 16, and the entire periphery of support 12 may have the same thickness, e.g., ¼ inch, as first plate 16. The thickness of other portions of support 16 may be the combined thickness of the first and second plates 16 and 18, e.g., ½ inch. The reduced thickness of support 12 at its periphery may reduce the likelihood that a person will trip on the support 12. To further reduce the likelihood of tripping on support 12, caution tape 28 may be disposed at various locations on the first (top) surface of first plate 18. Caution tape 28 may be any suitable tape or marking configured to call attention to the presence of support 12 such as, black and yellow striped tape. Support 12 may weigh about 125 pounds, or may have another suitable weight.

A pair of aligned pegs 20 may extend from a first surface (e.g., a top surface) of second plate 18. Pegs 20 may be laterally spaced from one another along a lateral axis 29 that is perpendicular to longitudinal axis 23. In one example, pegs 20 may be spaced from one another by about 0.5 inches, although other suitable spacings are contemplated so long as it allows for multiple frame supports to be coupled to the pegs 20 as described in detail below. Pegs 20 may be hollow having a 12 inch length and a 1⅜ inch outer diameter, although other suitable dimensions are also contemplated. It is further contemplated that pegs 20 may be solid members. Pegs 20 may be disposed closer to the second end 42 of support 12 than to the first end 40.

As noted above, the second (bottom) surface of first plate 16 may include an anti-skid membrane 24 or coating to help prevent support 12 from sliding on the ground surface during use. The presence of membrane 24 may obviate the need to anchor support 12 to the ground. Membrane 24 may be a rubberized membrane, such as, for example a non-slip, sanded surface. Membrane 24 may be, e.g., a 53 mil thick self-adhesive membrane composed of elastomeric bitumen with glass mat reinforcement. The membrane 24 may include a removable silicone treated release sheet on the self-adhesive side which can be removed to attach the self-adhesive side to the first plate 16. One example is the Grip Rite Eave and Valley Protector.

Fence panel 14 may include a frame 50 and an expanded metal mesh 52 that overlaps the entire frame panel 14. Frame 50 may include an outer frame 54 and an inner frame 56 formed by a plurality of steel tubes welded or otherwise secured together. Outer frame 54 may form square or rectangle shape and include vertical side tubes 55, 57, that are open at one of the top or bottom, or both. When fence system 10 is assembled, side tubes 55, 57 may extend normal to the length of supports 12 or normal to the ground surface. The side tubes 55, 57 may extend over and/or receive features of pegs, hinges, spacers, or the like. The inner frame 56 may include, for example, four tubes extending from the outer frame 54 to a central location 58 of the fence panel 14.

As noted above, expanded metal mesh 52 may be sized to overlap the outer frame 54 of fence panel 14 and be secured thereto. As used herein, overlapping the frame may correspond to the expanded metal mesh 52 having a perimeter that is at least large as the minimum perimeter of the outer frame 54 so that no gaps exist between the frame 54 and the expanded metal mesh 52. Expanded metal mesh 52 may also be secured to the inner frame 56. The expanded metal mesh 52 may only be secured on one side of the frame 50 as shown, or may be secured to both sides of frame 50 by welding or any other securing arrangement. The expanded metal mesh may be fixed to the frame 50. In one example, the expanded metal mesh may be secured only on the side of frame 50 facing second end 42. In a crowd-control setting, the expanded metal mesh may be secured on the side of outer frame 52 facing the crowd. Thus, because metal mesh 52 may overlap the entirety of the side of the frame facing second end 42 (the side facing the crowd), the metal mesh 52 may block portions of frame 50 from being used as footholds or handholds for climbing by persons on the crowd side of the fence system 10. The frame 50 may not be accessed from the second end 42 of support 12 without extending through a plane defined by the expanded metal mesh 52. The expanded metal mesh 52 may be standard or flattened, and may have any coating, for example, a polyester coating.

Portions of outer frame 54 may be extended over pegs 20 in order to secure fence panels 14 to supports 12. Thus, as shown in FIG. 1, a first portion of outer frame 54 may be extended over a peg 20 of a first support 12, while a second portion of outer frame 54 may be extended over a peg 20 of a second support 12′ that may be substantially similar to first support 12. Once assembled, the length of support 12 may be perpendicular to the fence plane of fence panel 14. As shown in FIG. 1, a second fence panel 14′ (shown partially in FIG. 1) may have an outer frame 54′ that may be extended over a peg 20 of second support 12′. The outer frames of adjacent fence panels 14 and 14′ may be coupled to one another by one or more tying members 60. Tying members 60 may be any suitable zip tie, cable tie, or other suitable linkage configured to wrap around outer frames 54 to secure adjacent fence panels to one another. Tying members 60 may be 250 pound cable ties which are wrapped around adjacent fence members twice before being secured (double-wrapped). In the example shown in FIG. 1, four tying members 60 are used to secure adjacent fence panels to one another, although any other suitable number may also be used. Once secured to one another, the gap between adjacent fence panels may be small in order to prevent, e.g., the passage of elicit materials or weapons from one side of the fence system 10 to the other side of the fence system 10.

In use, the second ends 42 of supports 12 may be positioned toward a crowd (e.g., a “crowd side” of fence system 10), while the first end 40 may be positioned toward a protected area (e.g., a “protected side” of fence system 10). Pegs 20 and fence panels 14 may be disposed closer to the crowd end of the fencing system 10 than the protected end of the fencing system 10 in order to make it more difficult for a person or persons on the crowd side to tip over fencing system 10.

Adjacent fence panels 14 may be usable with one another even on graded surfaces. In such examples, a first fence panel may be able to align with a first peg 20 of a given support 12, but a second fence panel may be unable to align with a second peg of the given support. In such an example, the bottom portion of the outer frame of the second fence panel may be positioned on the surface of the support 12 on the crowd side of the exposed second peg 20, but not positioned over the second peg 20 as discussed above. The second fence panel may thus also be disposed on the crowd side of the first fence panel and the respective peg 20. This arrangement may allow for the exposed second peg 20 to help prevent the second fence panel from moving toward the protected side of the fence.

FIGS. 4 and 5 depict an alternative support 412 which may be similar to support 12 except that support 412 may have a first plate 416 and a second plate 418 that may have different dimensions and/or properties than first plate 16 and second plate 18 described above. Second plate 418 may be secured to first plate 416 so that the perimeter edges of second plate 418 are not aligned with the perimeter edges of first plate 416. First plate 416 may be rectangular, and may be 48 inches by 28 inches with a ¼ inch thickness. The second plate 418 may have dimensions, for example, of 44 inches by 24 inches with a thickness of ¼ inch. Second plate 418 may include one or more weld holes 426 that are configured to facilitate the joining of first plate 416 with second plate 418 in a substantially similar manner as described above, except that in the example shown in FIG. 4, second plate 418 includes six weld holes 426. Support 412 may extend from a first (protected) end 440 toward a second (crowd) end 442, and may include a pair of laterally spaced pegs 420 that are disposed closer to second end 442 than first end 440. Support 412 may be heavier than support 12. For example, support 412 may weigh 175 pounds, and may be interspersed throughout a fencing system 10 to provide additional stability to the fencing system. In some examples, supports 412 may be used in lieu of supports 12 at the terminal ends of a fencing system. In some examples, supports 412 may be used as every fifth support in a line of supports, at ends of the fence, at corners of the fence, and/or at gated sections, or in any place that additional stability is desired.

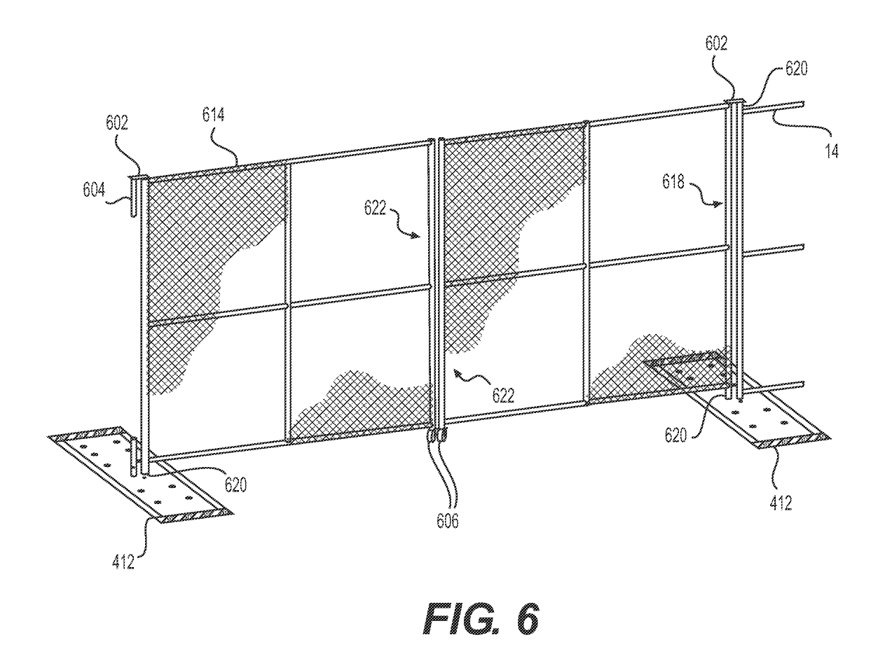

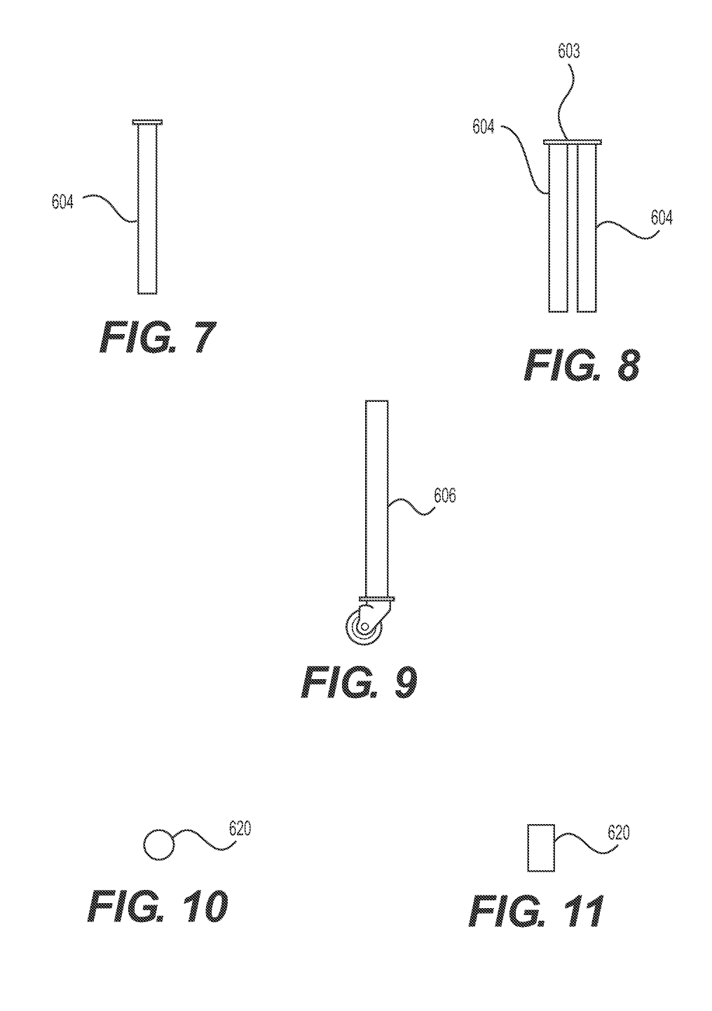

FIG. 6 depicts a double swing gate section formed by two supports 412 and two gate panels 614 that may be modified to function as gates. Each gate panel 614 may be identical to gate panels 14 described above. Gate panels 614 may be coupled at the top of one end with a hinge member 602 (shown also in FIGS. 7 and 8). Hinge member 602 may include a flattened portion 603 and two pegs 604 that extend from flattened portion 603 in the same direction. The spacing between pegs 604 may be substantially similar or equal to the spacing between pegs 20 described with reference to FIGS. 1-3. One peg 604 may be inserted into the top of the outer frame of a gate panel 614, while the other peg 604 may be inserted into the top of an outer frame of a panel 14 that is adjacent to gate panel 614. The outer frame of the gate panel 614 may have clearance when extended over a peg 604 in order to provide relative movement. That is, the clearance between the outer frame of gate panel 614 may allow gate panel 614 to pivot about hinge end 618.

A caster 606, shown also in FIG. 9, may be inserted into the bottom side of the outer frame of a gate panel 614 at a caster end 622 opposite from where hinge portion 602 is coupled to gate panel 614. This configuration may allow a gate panel to pivot about the hinge end 618 of gate panel 614 where hinge portion 602 is disposed. A gate spacer ring 620 shown in FIGS. 6, 10 and 11 may be used on the bottom of the hinge end 618 to align the height of hinge end 618 with the caster end 622. A spacer ring 620 may also be included at the top of fence panel 14 located adjacent hinge end 618.

While two gates are shown in FIG. 6, it is contemplated that a single gate may be utilized. In a two gate system, the caster ends 622 of adjacent gate panels 614 may be secured to one another when the gates are closed. In a one gate system, the caster end 622 of a gate panel 614 may be secured to, for example, a fence panel 14.

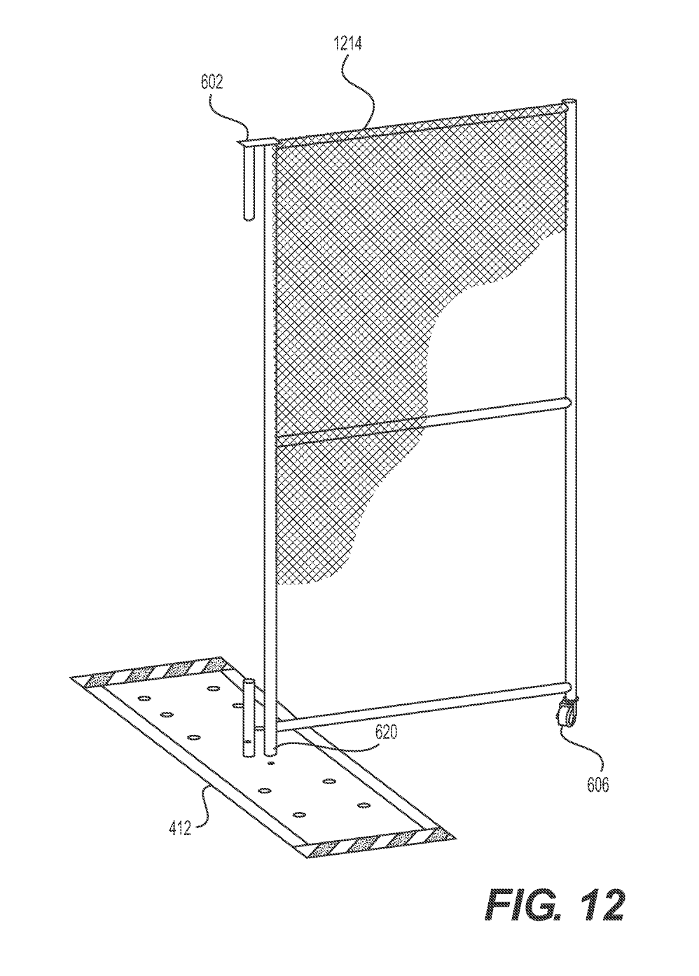

FIG. 12 depicts a single swing gate section utilizing a gate panel 1214 that is smaller than gate panel 614.

The fence systems of the present disclosure may be both anti-scale and anti-climbing, providing no handholds or footholds to assist a person in climbing the fences. This is based, for example, on the positioning of the expanded metal mesh over the entire frame and on the crowd side of the fence system 10. The disclosed fence systems may be free standing and avoid the need for any attachment to underlying surfaces. This feature is assisted by the weight of the system and anti-skid membrane 24 or coating. The disclosed fence systems may have no exposed hardware, and may be rapidly constructed and deconstructed. The disclosed fence systems may be crowd-resistant and wind-resistant, and may be resistant to tipping or sliding. The disclosed fence systems reduce tripping hazards by having a thinner thickness around the entire periphery of the fence supports, and the spacing of the pegs may maintain a small gap between fence panel and gates to assist in preventing the passage of weapons from one side of the fence system to the other side of the fence system.

Any aspect set forth in any example may be used with any other example set forth herein. It will be apparent to those skilled in the art that various modifications and variations can be made in the disclosed systems and processes without departing from the scope of the disclosure. Other examples of the disclosure will be apparent to those skilled in the art from consideration of the specification and practice of the disclosure disclosed herein. It is intended that the specification and examples be considered as exemplary only. The following disclosure identifies some other examples.

1. A temporary fence support, comprising:
a first plate having a first surface and a second surface, the first and second surfaces extending from a first end of the support toward a second end of the support, an entirety of the first plate being flat;
a second plate coupled to the first surface of the first plate, the second plate being smaller than the first plate and spaced apart from each of the edges of the first plate when viewed from a perspective above the fence support, wherein a length and a width of the second plate are each smaller than a respective length and width of the first plate; and
a first peg and a second peg each extending normal from the second plate, wherein the fence support is free-standing.

2. The fence support of claim 1, wherein the first peg and the second peg are each disposed closer to the second end of the support than to the first end of the support.

3. The fence support of claim 1, wherein the first peg and the second peg are offset from one another.

4. The fence support of claim 1, wherein both the first plate and the second plate are rectangular.

5. The fence support of claim 1, wherein the first surface and the second surface of the first plate are generally parallel to one another, and wherein the second surface includes an anti-skid material.

6. The fence support of claim 1, wherein the first surface of the first plate includes caution tape.

7. (canceled)

8. The fence support of claim 1, wherein the first plate and the second plate have the same thickness.

9. A temporary fence assembly, comprising:
a first fence support including:
a first plate having a first surface and a second surface, the first and second surfaces extending from a first end of the first fence support toward a second end of the first fence support;
a second plate coupled to the first surface of the first plate, the second plate being smaller than the first plate and offset from each edge of the first plate; and
a first peg and a second peg each extending normal from the second plate, wherein the first peg and the second peg are disposed closer to the second end of the first fence support than to the first end of the first fence support;
a first fence panel having a first outer frame having a first side facing the first end of the first fence support, and a second side facing the second end of the first fence support, wherein a first portion of the first fence panel extends over the first peg of the first fence support to couple the first fence panel to the first fence support, the first fence panel further includes a first expanded metal mesh overlapping an entirety of the second side of the first outer frame, and wherein the first expanded metal mesh helps protect against the first outer frame of the first fence panel from being used as a foothold or a handhold for climbing the fence assembly by a person disposed adjacent to the second end of the first fence support; and
a second fence panel having a second outer frame having a first side facing the first end of the first fence support, and a second side facing the second end of the first fence support, wherein a first portion of the second fence panel extends over the second peg of the first fence support to couple the second fence panel to the first fence support, the second fence panel further includes a second expanded metal mesh overlapping an entirety of the second side of the second outer frame, and wherein the second expanded metal mesh helps protect against the second outer frame of the second fence panel from being used as a foothold or a handhold for climbing the fence assembly by a person disposed adjacent to the second end of the first fence support, wherein the first expanded metal mesh and the second expanded metal mesh lie in a same plane and do not overlap at any point, and wherein the fence assembly is free-standing.

10. (canceled)

11. The fence assembly of claim 9, further including one or more tying members secured around both the first fence panel and the second fence panel that directly couple the first fence panel and the second fence panel to one another.

12-14. (canceled)

15. The fence assembly of claim 9, wherein the second fence panel is a gate that is configured to pivot about the second peg.

16. The fence assembly of claim 15, further including a spacer ring extending over a lower portion of the second peg and above a top surface of the second plate, wherein a hinged side of the second fence panel extends over the second peg and rests on the spacer.

17. (canceled)

18. The fence assembly of claim 9, further including a second fence support that is heavier than the first fence support, the second fence support including:
a first plate having a first surface and a second surface, the first and second surfaces extending from a first end of the second fence support toward a second end of the second fence support;
a second plate coupled to the first surface of the first plate, the second plate being smaller than the first plate and offset from each edge of the first plate; and
a first peg and a second peg each extending normal from the second plate, wherein a second side of the second fence panel extends over the first peg of the second fence support.

19. A temporary fence assembly, comprising:
a first fence support including:
a first plate having a first surface and a second surface, the first and second surfaces extending from a first end of the first fence support toward a second end of the first fence support, an entirety of the first plate being flat;
a second plate coupled to the first surface of the first plate, the second plate being smaller than the first plate and offset from each of the edges of the first plate, wherein the second plate is spaced apart from each of the edges of the first plate when viewed from a perspective above the first fence support, a length and a width of the second plate are each smaller than a respective length and width of the first plate, both the first plate and the second plate are formed of metal, an outer periphery and an outer thickness of the first fence support is defined only by an outer periphery and an outer thickness of the first plate to reduce the likelihood of a person tripping over the outer periphery of the first fence support, and wherein the fence assembly is configured to help protect against people disposed adjacent to the second end of the first fence support from scaling the fence assembly and from reaching an area disposed adjacent to the first end of the first fence support; and
a first peg and a second peg each extending normal from the second plate, wherein the first peg and the second peg are disposed closer to the second end of the first fence support than to the first end of the first fence support;
a first fence panel having:
a first frame having a first side facing the first end of the first fence support, and a second side facing the second end of the first fence support, and
a first expanded metal mesh overlapping an entirety of the second side of the first frame of the first fence panel, wherein a first portion of the first fence panel extends over the first peg of the first fence support to couple the first fence panel to the first fence support, wherein the first frame of the first fence panel defines the outer edges of a first fence plane, and wherein along any projection of the first fence plane that is parallel to the first fence plane, no portion of the first frame is disposed closer to the second side of the first fence support than the first expanded metal mesh, wherein the first expanded metal mesh helps protect against the first frame of the first fence panel from being used as a foothold or a handhold for climbing the fence assembly by a person disposed adjacent to the second end of the first fence support; and
a second fence panel having:
a second frame having a first side facing the first end of the first fence support, and a second side facing the second end of the first fence support, and
a second expanded metal mesh overlapping an entirety of the second side of the frame of the second fence panel, wherein a first portion of the second fence panel extends over the second peg of the first fence support to couple the second fence panel to the first fence support, wherein the second frame of the second fence panel defines the outer edges of a second fence plane, and wherein along any projection of the second fence plane that is parallel to the second fence plane, no portion of the second frame is disposed closer to the second side of the first fence support than the second expanded metal mesh, wherein the second expanded metal mesh helps protect against the second frame of the second fence panel from being used as a foothold or a handhold for climbing the fence assembly by a person disposed adjacent to the second end of the first fence support, wherein the first expanded metal mesh and the second expanded metal mesh lie in a same plane and do not overlap at any point, and wherein the fence assembly is free-standing.

20-22. (canceled)

23. The fence assembly of claim 19, further including an anti-skid membrane on the second surface of the first plate.

24. The fence assembly of claim 23, wherein the first expanded metal mesh is welded to the first frame, and the second expanded metal mesh is welded to the second frame.
